(19) United States
(12) Patent Application Publication
(10) Pub. No.: US 2009/0075246 A1
(43) Pub. Date: Mar. 19, 2009

(54) SYSTEM AND METHOD FOR QUANTIFYING STUDENT'S SCIENTIFIC PROBLEM SOLVING EFFICIENCY AND EFFECTIVENESS

(75) Inventor: Ronald H. Stevens, Marina del Rey, CA (US)

Correspondence Address: PROCOPIO, CORY, HARGREAVES & SAVITCH LLP, 530 B STREET, SUITE 2100, SAN DIEGO, CA, 92101, US

(73) Assignee: THE LEARNING CHAMELEON, INC., Marina del Rey, CA (US)

(21) Appl. No.: 12/211,661

(22) Filed: Sep. 16, 2008

Related U.S. Application Data
(60) Provisional application No. 60/973,250, filed on Sep. 18, 2007.

(51) Int. Cl. G09B 3/00

(52) U.S. Cl. 434/322

(57) ABSTRACT

In a computer implemented system and method for analyzing problem solving abilities, analytic models are produced to quantify how students construct, modify and retain problem solving strategies as they learn to solve science problems online. Item response theory modeling is used to provide continually refined estimates of problem solving ability as students solve a series of simulations. In parallel, student's strategies are modeled by self-organizing artificial neural network analysis, using the actions that students take during problem solving as the classifying inputs. This results in strategy maps detailing the qualitative and quantitative differences among problem solving approaches. The results are used to provide reports of strategic problem solving competency for a group of students so that teachers can modify teaching strategies to overcome noted deficiencies.

### RELATED APPLICATION

The present application claims the benefit of co-pending U.S. provisional patent application No. 60/973,520, filed Sep. 18, 2007, the contents of which are incorporated herein by reference in their entirety.

### BACKGROUND

1. Field of the Invention

The present invention relates generally to quantifying student's problem solving efficiency and effectiveness by analysis of student's problem solving data and use of such analysis as a feedback to students and teachers.

2. Related Art

Promoting students' ability to effectively solve problems is viewed as a national educational priority. However, teaching problem solving through school-based instruction is no small task and many teachers may find it difficult to quantify and assess students' strategic thinking in ways that can rapidly inform instruction.

Part of the assessment challenge is cognitive. Strategic problem solving is a complex process with skill level being influenced by the task, the experience and knowledge of the student, the balance of cognitive and metacognitive skills possessed by the student and required by the task, gender, ethnicity, classroom environment and overall ability constructs such as motivation and self efficacy. It is further complicated as the acquisition of problem solving skills is a dynamic process characterized by transitional changes over time as experience is gained and learning occurs.

Other challenges are observational in that assessment of problem solving requires real-world tasks that are not immediately resolvable and that require individuals to move among different representations. Assessment also requires that performance observations be made that are revealing of the underlying cognition and can also be effectively reported. Tasks meeting these criteria are becoming more common in science classrooms, and with the increasing technology capabilities, the cognitive granularity of the assessments can become detailed. However, granularity can come at the cost of generalization, ease of implementation, and clarity of understanding. Finally, there are the technical challenges of speed and scale; speed relating to how rapidly valid inferences can be made and reported from the performance data, and scale in how multiple content domains and grade levels can be effectively compared.

There are a number of problems in building assessments that can provide useful feedback for any kind of learning, much less problem solving. First, the findings from such assessments typically take a long time to develop. For instance, performance assessments—while useful for assessing higher levels of thinking—might take middle and high school teachers a week or more to score. With the development of increasingly powerful online learning environments and the coupling of these environments to dynamic assessment methodologies, it is now becoming possible to rapidly acquire data with linkages to the students' changing knowledge, skill and understanding as they engage in real-world complex problem solving. This can be accomplished both within problems as well as across problems.

It is also difficult to determine the most important features of the student data streams and refine them into a form useful in deciding how best to improve performance. A range of tools are being employed in current analyses, including Bayesian Nets, Computer Adaptive Testing (CAT) based on Item Response Theory (IRT), regression models, and artificial neural networks (ANN), each of which possesses particular strengths and limitations. One emerging lesson however, is that a single approach is unlikely to be adequate for modeling the multitude of influences on learning as well as for optimizing the form of subsequent interventions. Technical and conceptual challenges are to develop system architectures that can provide rigorous and reliable measures of student progress, yet can also be progressively scaled and refined in response to evolving student models and new interventional approaches.

### SUMMARY

Embodiments described herein provide a method and system for analyzing problem solving efficiency and effectiveness using models (predictive simplifications or abstractions) to position students on learning curves and providing reports on student progress in problem solving over time, comparison between students, program effectiveness, and performance standards for different groups or classes. The resulting reports may be used to provide feedback tools to teachers to assess student and class performance so that individual students or groups of students requiring intervention or additional teaching or alternative teaching methods can be identified, as well as teachers having the most effective teaching techniques so that information or training on such techniques can be provided to other teachers having less effective teaching techniques.

According to one aspect, a method of analyzing problem solving ability is provided, which comprises collecting problem solving data for a group of users such as students for different problems attempted by the students and similar problem solving attempts by the same students at different times, the data including correctness of answers and resources used by students to obtain the answers, processing the collected data to provide a quantitative numeric value (QV) for each student's problem solving ability, storing the QV data over time for individual students, selected groups of students, and different types of problems, and combining the stored QV data to produce output reports of all student performances for all problems, all student performances for a selected problem, all student performances in a selected student group, and individual student performances.

The reports may be used as feedback for comparison purposes, for tracking improvement of individual students or groups over time, comparing results for students in different classes and with different teachers attempting the same problems, and for suggesting possible interventions to improve the problem solving abilities in students or classes identified as having low QV scores. In one embodiment, the QV scores are determined by providing a plot of the average problem solve rate of a group of problems for a plurality of students to the student's problem solving strategic efficiency, dividing the plot into four quadrants and assigning the quantitative value (QV) which combines strategic efficiency and correctness or effectiveness to each quadrant. The strategic efficiency is expressed in terms of the resources available (what information can be gained) and the costs of obtaining the information. Effectiveness corresponds to correctness of answers. Students who review all available resources are not being very efficient, although they might eventually find enough information to arrive at the right answer. Other students might not look at enough resources to find the information necessary to solve the problem, i.e., they are being efficient but at the cost of being ineffective. Students demonstrating high strategic efficiency should make the most effective problem-solving decisions using the fewest number of the resources available. In contrast, students with lower efficiency levels require more resources to achieve similar outcomes or fail to reach acceptable outcomes.

As students gain experience with solving problems in different science domains, this should be reflected as a process of resource reduction. The core components of strategic efficiency are 1) the quantity of resources used vs. the quantity available, 2) the value of the resulting outcomes expressed as a proportion of the maximum outcomes, and 3) the quality of the data accessed. By analyzing students' problem solving behavior in terms of effectiveness and efficiency, a generalized problem solving metric has been derived and partially validated that is applicable across domains and classrooms, and can be used to monitor progress throughout the year. The quantity and quality of the resources accessed (i.e. strategic efficiency) is derived from artificial neural network analysis, and the outcome value (problem solving effectiveness) is derived from the problem solution frequency and/or Item Response Theory (IRT) ability estimates.

Additional variables may be stored and used in preparing different types of performance reports, include the teachers assigned to students in the group, standardized test scores for students in the group, different types of problem sets, and calculated QVs for the same students attempting similar problems using problem attempt data taken at periodic intervals. The reports enable both teachers and students to monitor problem solving progress for different problem sets, different teachers, and over successive time intervals such as semesters or even years. Teachers may use the QV reports to track class progress as a means of monitoring the effectiveness of their own teaching, while principals or other staff members may use the reports to target teacher professional development in ways that address trends in class level problem solving, and can then track whether the professional development succeeded in improving QV levels of students in the classroom. The QV reports for individual students also provide a way to assess students rapidly.

While the challenges for developing problem solving assessments are substantial, the real-time generation and reporting of metrics of problem solving efficiency and effectiveness may help to fulfill many of the purposes for which educational assessments are used, including evaluation, policy development, grading, and feedback for improving teaching and learning.

The outputs of the above method should be very quickly available. Results from the assessment may be linked to interventions that teachers might use with individual students or the class as whole. Results may be analyzed across learning events so that students and teachers can track growth (or lack of growth) in learning.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of one embodiment of a system for analyzing problem solving efficiency and effectiveness;

FIG. 2 is a more detailed block diagram of the data base module of FIG. 1;

FIG. 3 is a more detailed block diagram of the central processing or server module and the report output module of FIG. 1;

FIG. 4 is a more detailed functional block diagram of a modified system including optional user collaboration functions;

FIG. 5 is a screen shot of a user input screen for the analysis system of FIGS. 1 to 4;

FIG. 6 is a diagram illustrating one example of a set of problems which may be used in the system of FIGS. 1 to 5 and an analysis of problem difficulty based on student performance data;

FIG. 7A is a sample neural network nodal analysis used in one embodiment of a method of analyzing problem solving efficiency and effectiveness;

FIG. 7B is an example of an artificial neural network (ANN) nodal map showing a topology of problem solving performances generated during a training process;

FIG. 8 illustrates a sample neural network nodal analysis combining the analyses of FIGS. 7A and 7B to produce tables of nodal solve rates and items viewed in connection with each nodal solve rate;

FIG. 9 illustrates one embodiment of a method of dividing the data on student strategy (efficiency) and problem solving outcomes (effectiveness) into four groups or quadrants and using this division to generate quantitative values (QV) for problem solving and using those values to track performance;

FIG. 10 is a schematic diagram illustrating the data modeling linkages in the analysis method of FIGS. 5 to 9;

FIG. 11 illustrates one example using the method of FIG. 9 to generate QVs using a specific set of data;

FIGS. 12A and 12B illustrate similar plots to FIG. 11 generating QVs for two different sets of data;

FIGS. 13A and 13B is an example of one embodiment of an output report or plot illustrating improvements in QV rates with practice for the data plotted in FIGS. 12A and 12B;

FIG. 14 illustrates an example of normalized QV score data;

FIG. 15 illustrates examples of reports generated by one embodiment of the system and method of FIGS. 1 to 14;

FIG. 16 illustrates an example of a plot of student standardized test scores against QV scores;

FIG. 17 illustrates an alternative analysis method of another embodiment which generates a bar chart modeling individual and group learning trajectories using ANN and HMM neural network analysis, using different criteria to represent problem solving strategies;

FIG. 18 is an example of a bar chart generated by the method of FIG. 17 in order to track and predict student's long-term term strategic approaches;

FIG. 19 is a similar bar chart which separates the data of FIG. 18 into gender-related strategic trajectories; and

FIG. 20 is a graphical illustration of the use of efficiency and effectiveness values to indicate the positive or negative learning effects of various problem solving interventions.

### DETAILED DESCRIPTION

Certain embodiments as disclosed herein provide for a system and method which analyzes students' problem solving behavior in terms of effectiveness and efficiency, and which generates various types of reports which may be used in teaching environments and the like to monitor progress and provide feedback for possible modification of teaching techniques or student intervention.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

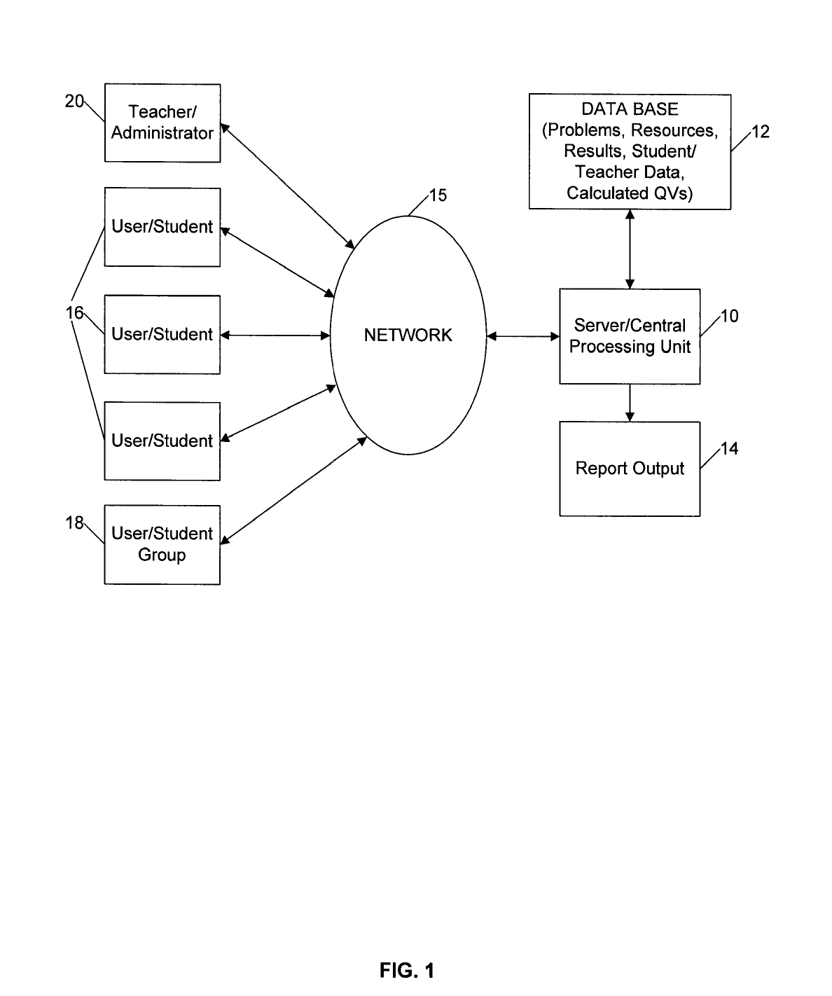

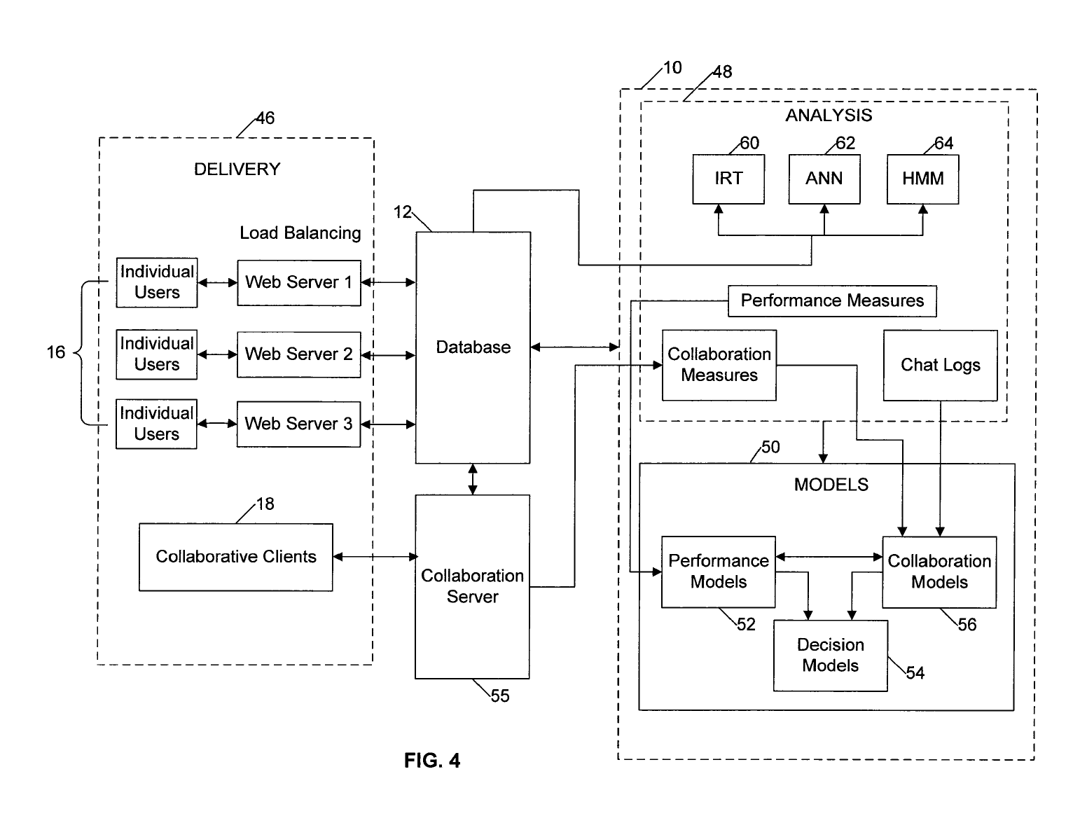

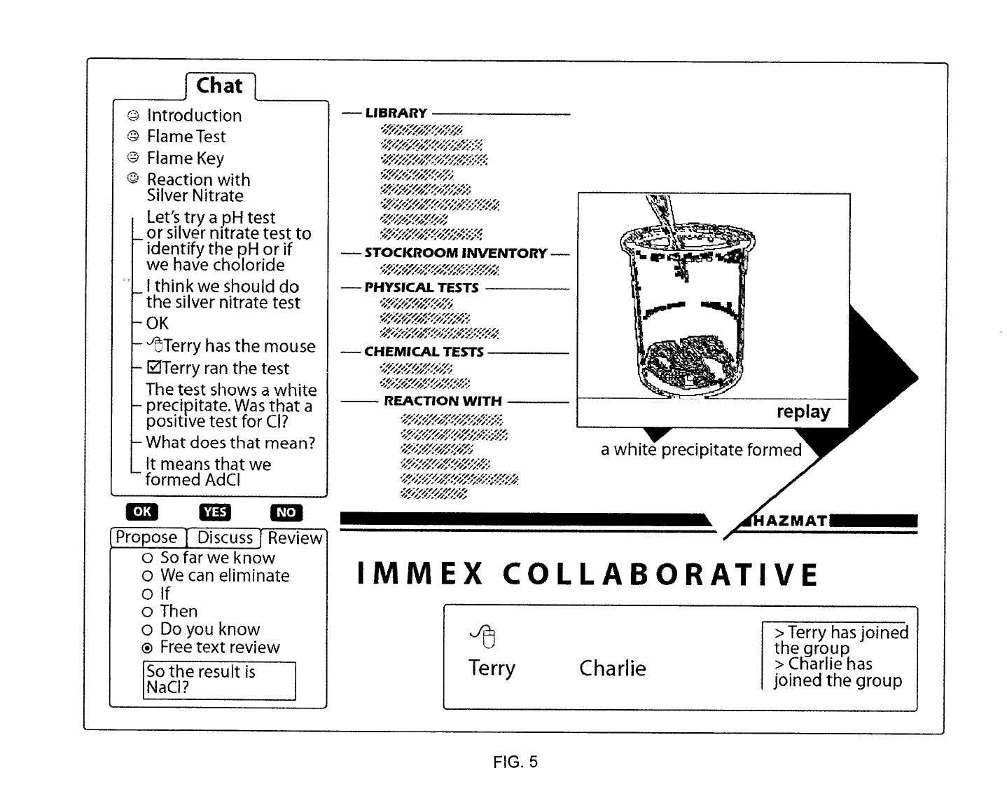

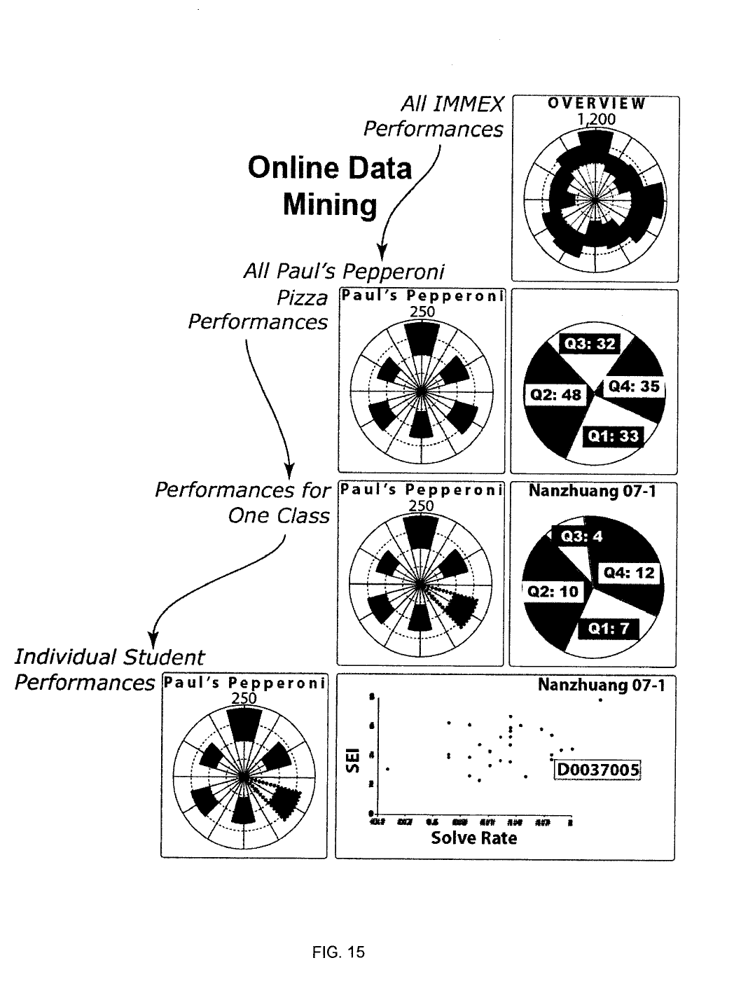

FIGS. 1 to 15 illustrate one embodiment of a system and method which analyzes student problem solving behavior based on efficiency and effectiveness of problem solving and produces various output reports for use by teachers, students, and/or administrators. FIGS. 1 to 3 are schematic block diagrams of the system and various components of the system, while FIG. 4 illustrates the system of FIG. 1 in more detail but with a modification to include collaborative data collection and analysis. FIGS. 5 to 15 illustrate one embodiment of a method of analyzing problem solving data to produce a quantitative value (QV) representative of problem solving efficiency and effectiveness, and various plots of the determined QV against other variables, with FIG. 15 illustrating some of the reports which may be generated in this system. Although the description below relates to a specific type of problem, specifically a chemistry problem, with the users of the system being students and teachers, the system may also be applied to other types of learners such as trainees, workers, professionals in various fields, and the like, and to other types of scientific, mathematic, or economic problems and the like, and to other problem solving situations not necessarily involving a traditional classroom situation.

As illustrated in FIGS. 1 and 4, the system basically comprises at least one central processing unit (CPU) or server 10 linked to a data base 12 and to a local or remote report output module 14 for providing various types of output reports on problem solving ability, as described in more detail below. In one embodiment, the server 10 may be associated with a website address which provides user access to the website over a public network 15 such as the Internet. The CPU 10 can be implemented as a server or computer. A similar computer or server 10 and data base 12 may be provided in a private network in alternative embodiments. FIG. 1 illustrates a plurality of individual users 16 or user groups 18 connected to server 10 via web servers 22 (FIG. 4) using a web browser on a communication device which may be a personal computer (PC), laptop computer, mobile device, or any other device capable of running web-browser software. Teachers or administrators 20 may be linked to the system in a similar manner so that they can view selected reports created by the system on line.

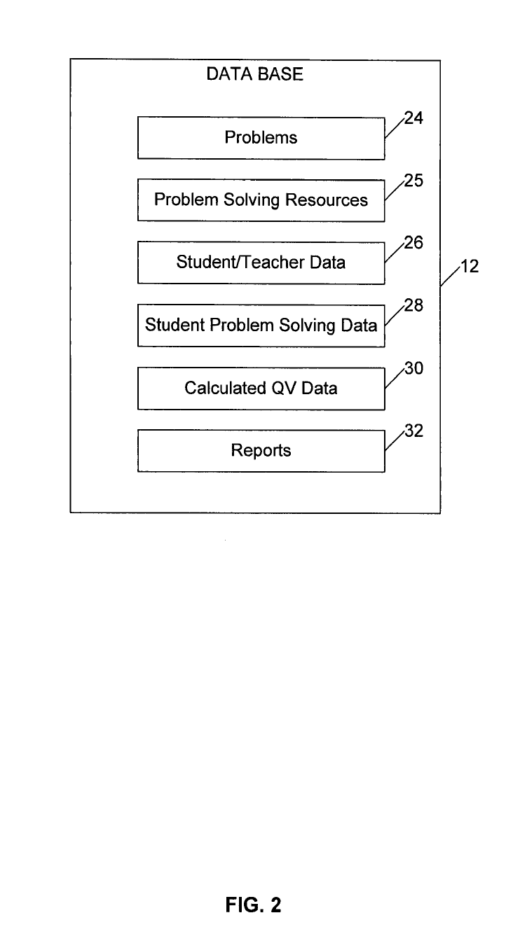

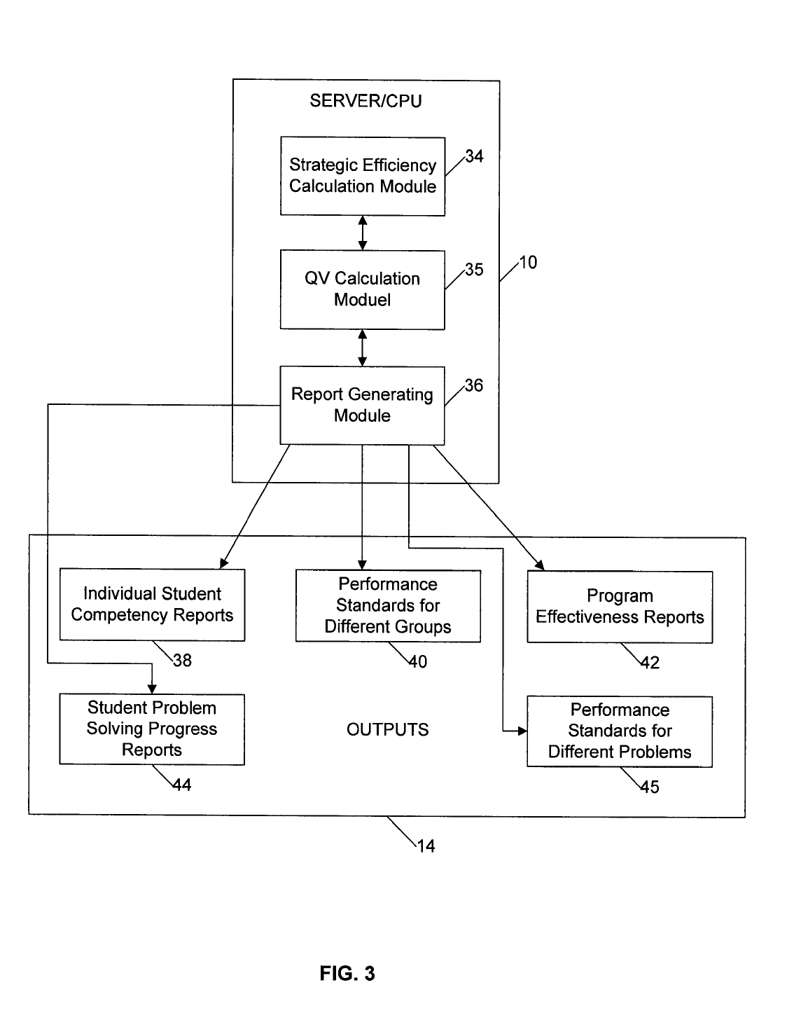

The report output module 14 in one embodiment is linked to administrators 20 either locally or over a network to display selected output reports on their communication device. It may also be used to provide certain output reports to student users in some embodiments. As illustrated in more detail in FIG. 2, data storage module 12 stores predetermined data such as problems to be solved 24, resources for solving the problems 25, student and teacher identifying data 26, and the like, as well as data generated by the system such as problem solving result data 28 based on student inputs to the system, including use of resources, QV data 30 calculated using data processing software in server or computer 10 to process the student inputs, and various reports 32 generated by the system based on QV and other data stored in the data base. As illustrated in FIG. 3, the server or CPU 10 includes a strategic efficiency calculation module 34, a QV calculation module 35, and a report generating module 36 which is programmed to generate various reports such as individual student competency reports 38, performance standards for different groups of students 40, student problem solving progress reports 42, program effectiveness reports 44, student performance data for each problem in the system 45, and the like.

FIG. 4 is a functional block diagram illustrating the system architecture and functions in more detail. From a systems architecture perspective, the system is a data-centric system centered around a SQL database or data base module 12 of both problem and performance data. It consists of delivery component or module 46, data component or module 12, analysis component or module 48 and modeling component or module 50. Analysis module 48 and modeling module 50 are provided as software in server 10 or additional servers connected to server 10 with direct or web services communications. Delivery module or component 46 may provide for up to 400 or more concurrent users each individually solving problems. In an optional alternative embodiment, delivery module 46 also allows for inputs from concurrent student groups 18 in order to test the effectiveness of collaborative problem solving.

The analytic or performance models 52 that provide the engine for suggesting interventions, focus on 1) effectiveness, as measured by Item Response Theory (IRT) analysis, and 2) strategies, as modeled by artificial neural network (ANN) and Hidden Markov Modeling (HMM). Effectiveness may also be measured by a determination of problem solving frequency. In one embodiment, the problem solving effectiveness and problem solving efficiency functions are both modeled in real time, but in different software modules, for efficiency and also since they may be assessing different constructs. The analyzed data can then be propagated and integrated back into decision/report models 54 as described below, for providing, or triggering interventions as needed.

For optional collaborative studies, the collaboration client runs in a browser and is managed through Java applets that communicate with an optional collaboration server 55. The Collaboration Server is an HTTP server acting as a proxy, which filters, edits, and synchronizes HTML pages associated with the problem solving system through JavaScript, and sends them to the clients. The database server records the student performance data and the collaboration server records the student chat log. These are subsequently merged during the chat modeling process to associate chat segments with the test selections in collaboration models 56.

In one embodiment, the system of FIGS. 1 to 4 includes an online problem solving delivery environment and layered analytic system termed IMMEX™ (Interactive Multi-Media Exercises), which has been used to develop and implement problem solving tasks that require students to analyze descriptive scenarios, judge what information is relevant, plan a search strategy, gather information, and eventually reach a decision(s) that demonstrates understanding. Other systems which store various problems and resource items to assist in solving the problems may be used as the data base of problem sets in alternative embodiments.

The IMMEX™ Project hosts an online problem solving environment and develops and delivers scientific simulations and probabilistic models of learning trajectories that help position students' scientific problem-solving skills upon a continuum of experience. Students access resource data such as experimental results, reference materials, advice from friends and/or experts, etc. to solve the problem. Their exploration of these resources is unconstrained in that they choose how many (or few) resources they use and in what order. Every IMMEX™ problem set includes a number of cases—parallel versions of the problem that have the same interface and resources, but present different unknowns, require different supporting data and have different solutions. The IMMEX™ database serializes and mines timestamps of which resources students use. While IMMEX™ problem solving supports the three cognitive components important for problem solving (e.g. understanding of concepts, understanding the principles that link concepts, and linking of concepts and principles to procedures for application); evaluation studies suggest that the second and third components are most emphasized by the IMMEX™ format.

In one embodiment, the system of FIGS. 1 to 4 uses machine-learning tools to build layers of student performance models that are used to assess student problem solving skills. The system may use data from multiple students, students in multiple classes with different teachers and at different schools, and may alternatively or additionally involve students who are located in remote or offsite learning environments using online tools. In one example, a dataset used in the system and method of FIGS. 1 to 4 included 154 classes from 64 teachers (mostly middle school) across 27 schools, with 79,146 problem performances.

Existing IMMEX™ problem solving follows the hypothetical-deductive learning model of scientific inquiry where students frame a problem from a descriptive scenario, judge what information is relevant, plan a search strategy, gather information, and eventually reach a decision that demonstrates understanding. Over 80 problem sets have been constructed in science and other disciplines and over 500,000 cases have been performed by students spanning middle school to medical school. (http://www.immex.ucla.edu). These constructed problem sets may be stored in problems module 24 of data base 12 for use in the system of FIGS. 1 to 4. Unlike the standard IMMEX™ system, the system of this embodiment goes beyond the standard outputs of plotting number of accurate answers for different problems and analyzes the effectiveness and efficiency of problem solving strategy on a student by student basis using a multi-layered analysis involving several different analysis techniques. The system and method of this embodiment is also designed to generate a number of reports which can be used as feedback by teachers or administrators to modify teaching strategies on an individual student or student group/class basis.

One of several problem sets researched extensively under IMMEX™ is a Hazmat problem, which provides evidence of students' ability to conduct qualitative chemical analyses. The problem begins with a multimedia presentation, explaining that an earthquake caused a chemical spill in the stockroom and the student's challenge is to identify the chemical. The problem space contains twenty menu items for accessing a Library of terms, the Stockroom Inventory, or for performing Physical or Chemical Testing. When the student selects a menu item, she verifies the test requested and is then shown a presentation of the test results (e.g. a precipitate forms in the liquid, as illustrated in the screen shot of FIG. 5. When students feel they have gathered adequate information to identify the unknown they can attempt to solve the problem. To ensure that students gain adequate experience, this problem set contains multiple cases that can be performed in class, assigned as homework, or used for testing.

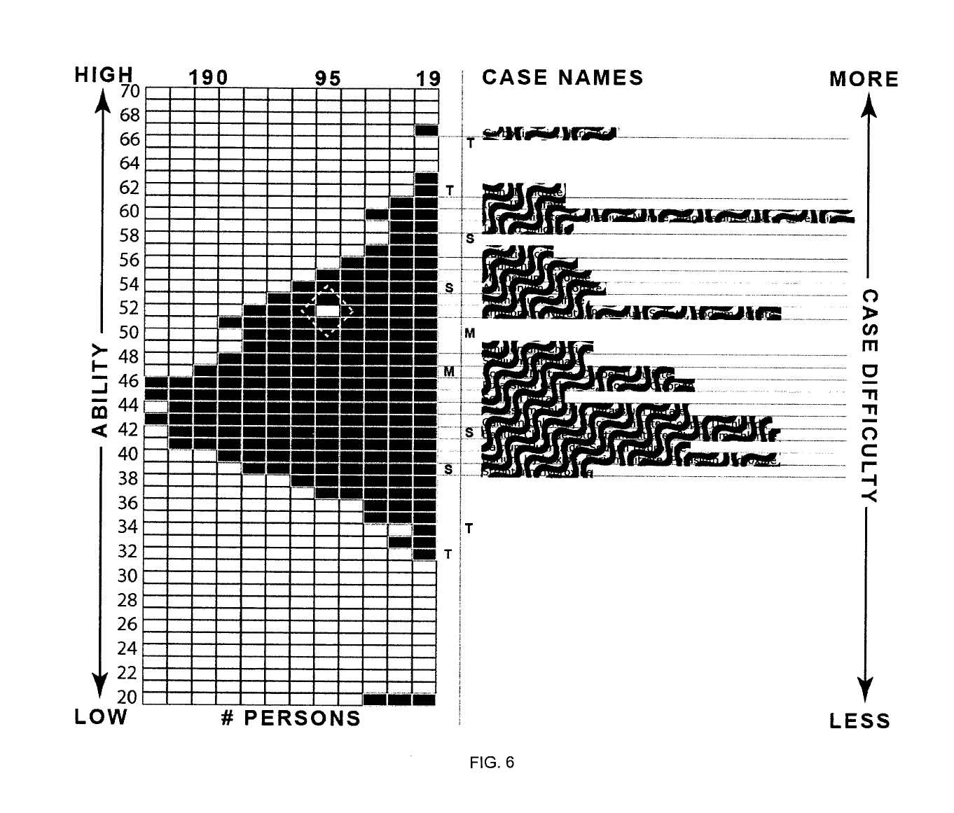

For Hazmat, the students are allowed two solution attempts, and the database 12 records these attempts as 2=solved on the first attempt, 1=solved on the second attempt, and 0=not solved. These results may be stored in student/teacher data module 26 together with other student identifying criteria, such as name, class, teacher, and potentially also other criteria for the student in question such as standardized test scores. As shown in FIG. 6, the cases in the problem set included a variety of acids, bases, and compounds that give either a positive or negative result when flame tested and were of a range of difficulties. The problem difficulty begins with the easiest at the bottom and increases towards the top. The distribution of student abilities is shown on the left with the highest ability students at the top, decreasing downwards. In the plot of FIG. 6, M indicates the mean, S, the standard deviation, and T two standard deviations.

As expected, the flame test negative compounds are more difficult for students because both the anion and cation have to be identified by running additional chemical tests. Overall, the problem set presents an appropriate range of difficulties to provide reliable estimates of student ability. Item Response Theory (IRT) analysis (see block 60 of FIG. 4) is the first measure of the multi-layered analytical approach and these estimates are updated in real-time with each case performance in student problem solving data module 28 of the data base 12. In the embodiment of FIGS. 1 to 14, cases or problems may be delivered randomly to students. IRT estimates may be computed in real time after each performance, and re-estimates may be made based on the next case or problem to be delivered, so as to provide the opportunity to deliver cases of defined difficulty to individual students in a computer adaptive testing approach.

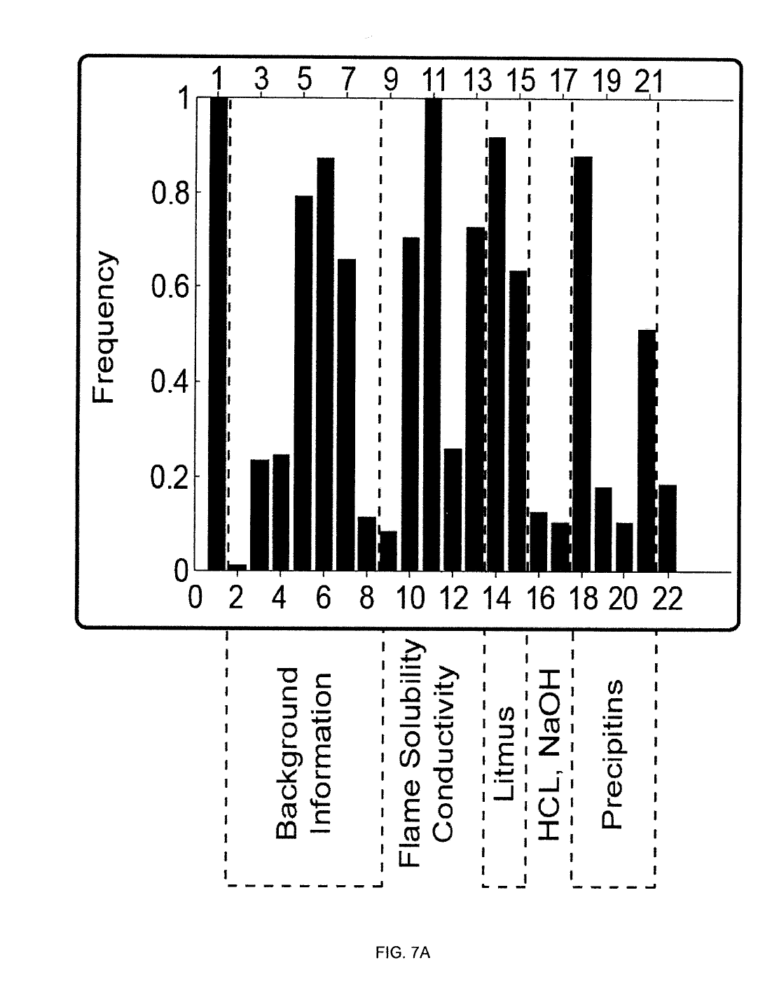

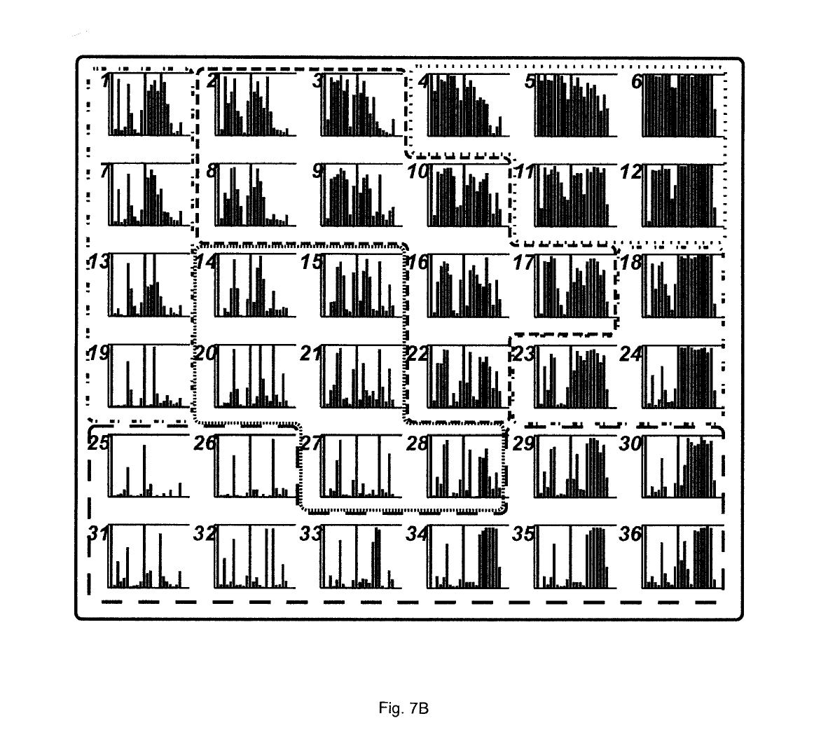

While useful for ranking the students by the effectiveness of their problem solving, IRT does not provide any measure of problem solving strategy or efficiency. In the system of FIGS. 1 to 14, artificial neural network (ANN) analysis (see block 62 of FIG. 4) is used to provide the strategic measures, i.e. analyzing how students approach and solve a problem. As students navigate the problem spaces, the database collects timestamps of each student selection and stores this data in the student problem solving data module 28 of data base 12. The most common student approaches (i.e. strategies) for solving Hazmat problems are identified with competitive, self-organizing artificial neural networks using these time stamped actions as the input data. The result is a topological ordering of the neural network nodes according to the structure of the data where geometric distance becomes a metaphor for strategic similarity. A 36-node neural network may be used and the details are visualized by histograms showing the frequency of items selected for student performances classified at that node, as illustrated for one example of an ANN analysis in FIG. 7A. Strategies so defined consist of actions that are always selected for performances at that node (i.e. with a frequency of 1) as well as ones ordered variably. The selection frequency of each action (identified by the labels in FIG. 7A) is plotted for the performances at node 15, and helps characterize the performances clustered at this node and for relating them to performances at neighboring nodes. FIG. 7B shows the item selection frequencies for all 36 nodes of this example, and maps them to Hidden Markov Model (HMM) states. FIG. 7B is a composite ANN nodal map that shows the topology of performances generated during the self-organizing training process. Each of the 36 matrix graphs represents one ANN node where similar students' problem solving performances have become competitively clustered. As the neural network was trained with vectors representing selected student actions, it is not surprising that a topology developed based on the quantity of items. For instance, the upper right of the map (nodes 6, 12) represents strategies where a large number of tests were ordered, whereas the lower left contains strategies where few tests were ordered. Once ANN's are trained and the strategies represented by each node defined, new performances can be tested on the trained neural network and the node (strategy) that best matches the new performance can be identified and reported.

On their own, artificial neural network analyses provide point-in-time snapshots of students' problem solving. Any particular strategy, however, may have a different meaning at a different point in a learning trajectory. More complete models of student learning should also account for the changes of student's strategies with practice. To model student learning progress over multiple problem solving episodes, students perform multiple cases in a selected problem set, such as the 38-case Hazmat problem set, and each performance may then be classified with the trained ANN. Some sequences of performances localize to a limited portion of the ANN topology map. For instance the nodal sequence {32, 33, 28, 33, 33} suggests only small shifts in strategy with each new performance. In this system, Hidden Markov Modeling (HMM—see block 64 of FIG. 4) may be used to extend the preliminary results to more predicatively model student learning pathways.

The central question which the system and method of FIGS. 1 to 15 seeks to answer is, “What is a suitable description of problem solving efficiency and correctness that can capture important cognitive and performance information about individual problem solving, yet provide rapid and meaningful comparisons within and across educational systems and science domains?” Correctness can be determined by assessing whether or not an outcome was successful, and this may be extended by Item Response Theory Analysis (IRT) estimates of θ (theta), to yield more refined performance estimates when cases of varying difficulties exist. Efficiency is another important component of problem solving which has been somewhat been more difficult to assess as constraints are involved, such as time, risks, costs, benefits, and available resources.

Students demonstrating high strategic efficiency should make the most effective problem solving decisions using the least number of resources available, whereas students with lower efficiency levels would require more resources to achieve similar outcomes and/or fail to reach acceptable outcomes. As problem solving skills are refined with experience, this should be reflected as a process of resource reduction.

The core components of strategic efficiency for resource utilization are therefore 1) the quantity of resources used vs. the quantity available, 2) the value of the resulting outcomes expressed as a proportion of the maximum outcomes, and 3) the quality of the data obtained. The first two components can be represented by Equation (1) below, which defines a resource-utilization Efficiency Index, termed EI. For IMMEX™ problems the maximum outcome is 2 (e.g. 2 points for solving the problem, 1 point for solving the problem on a second attempt, and 0 pts for missing the solution).

$$E {I}_{R} = ( \frac{obtained outcome}{max outcome} / \frac{resources used}{resources available} ) \qquad ( 1 )$$

Not all resources available in a problem space are equally applicable to the particular problem at hand, and different combinations of resources have different strategic value within the contexts of different problems. Thus, estimates of the quality of resources used are also required. This qualitative dimension is derived from strategic classifications derived from unsupervised artificial neural network (ANN) clustering of performances.

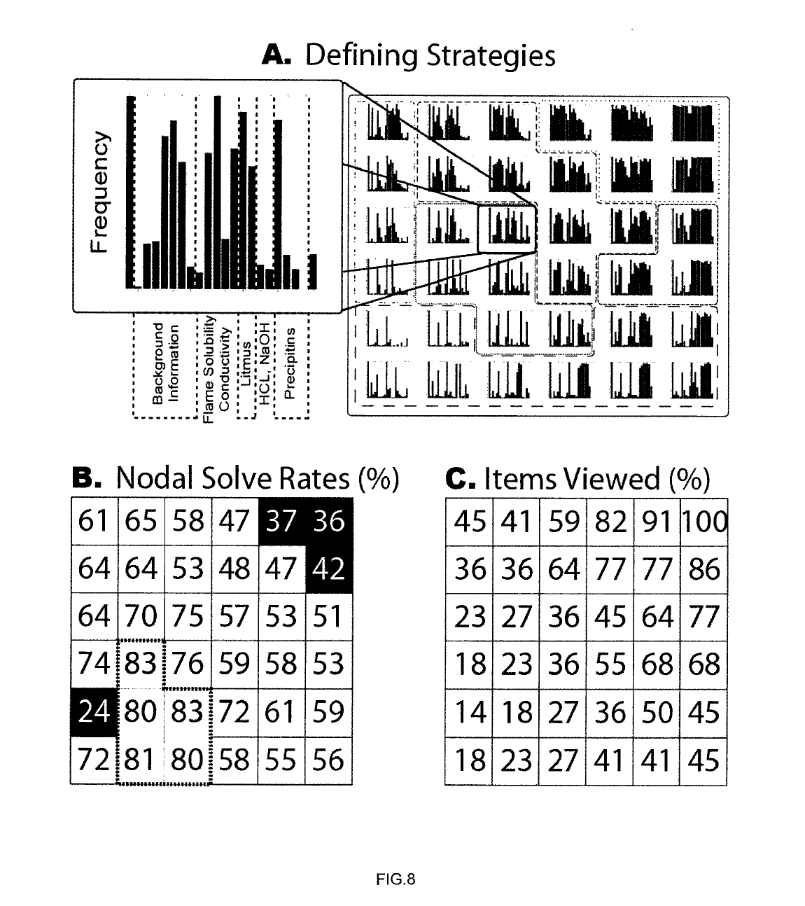

FIG. 8 illustrates an example of a neural network analysis combining the analyses of FIGS. 7A and 7B in part A of FIG. 8. FIG. 8B shows the item selection frequencies for all 36 nodes where the nodes are numbered in rows, 1-6, 7-12, etc. The solution rate for each node is listed with the lowest solved rates in black and the highest in white in FIG. 8C. The values indicate the proportion of tests selected during performances at each node.

As shown in FIG. 8B, not all strategies result in the same outcomes. Some of the strategies such as those represented by nodes 5, 6 and 12 are neither efficient (many items selected), nor effective (low solve rate) and are characterized by a detailed examination of the problem space, often without solving the problem. These therefore represent poor outcomes with extensive resource utilization. Other strategies, represented by nodes 26, 32 or 19, have high solve rates, with limited use of the laboratory tests, representing efficient and effective outcomes. Node 25 most likely represents guessing as the solve rate is very low and only a few tests are ordered. The proportion of tests selected at each node is then calculated using 50% as a cutoff value. Thus the efficiency components needed for the EI measure can be derived from the trained ANN. The equation above yields a simple exponential curve with a minimum approaching 0 where there are no/poor outcomes with extensive resource utilization and a varying maximum depending on the value of the absolute quantity of resources available.

The problem solving analysis described above is based on the concepts of efficiency and effectiveness. In these terms, Effectiveness is ‘Doing the right thing’ and Efficiency is ‘Doing the thing right.’ In other words, efficiency is a productivity metric concerned about the means and effectiveness is a quality metric concerned about the ends. These ideas can be mapped to two important components of problem solving, outcomes and strategies.

Efficiency in problem solving is expressed in terms of the resources available (what information can be gained) and the costs of obtaining the information. Students who review all available resources are not being very efficient, although they might eventually find enough information to arrive at the right answer. Other students might not look at enough resources to find the information necessary to solve the problem, i.e., they are being efficient but at the cost of being ineffective. Students demonstrating high strategic efficiency should make the most effective problem-solving decisions using the fewest number of the resources available. In contrast, students with lower efficiency levels require more resources to achieve similar outcomes or fail to reach acceptable outcomes.

As students gain experience with solving problems in different science domains, this should be reflected as a process of resource reduction. The core components of strategic efficiency are 1) the quantity of resources used vs. the quantity available, 2) the value of the resulting outcomes expressed as a proportion of the maximum outcomes, and 3) the quality of the data accessed. By analyzing students' problem solving behavior in terms of effectiveness and efficiency, a generalized problem solving metric is produced, which is applicable across domains and classrooms, and can be used to monitor progress throughout the year. The quantity and quality of the resources accessed (i.e. strategic efficiency value) for each problem solving attempt is derived from artificial neural network analysis, as described above in connection with FIGS. 7 and 8, and the outcome value (problem solving effectiveness value) is derived from the problem solution frequency and/or Item Response Theory (IRT) ability estimates, as described above in connection with FIG. 6.

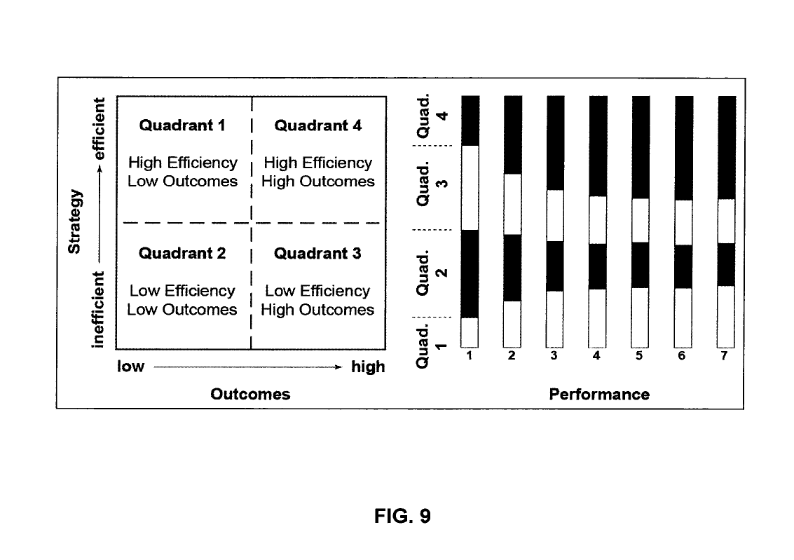

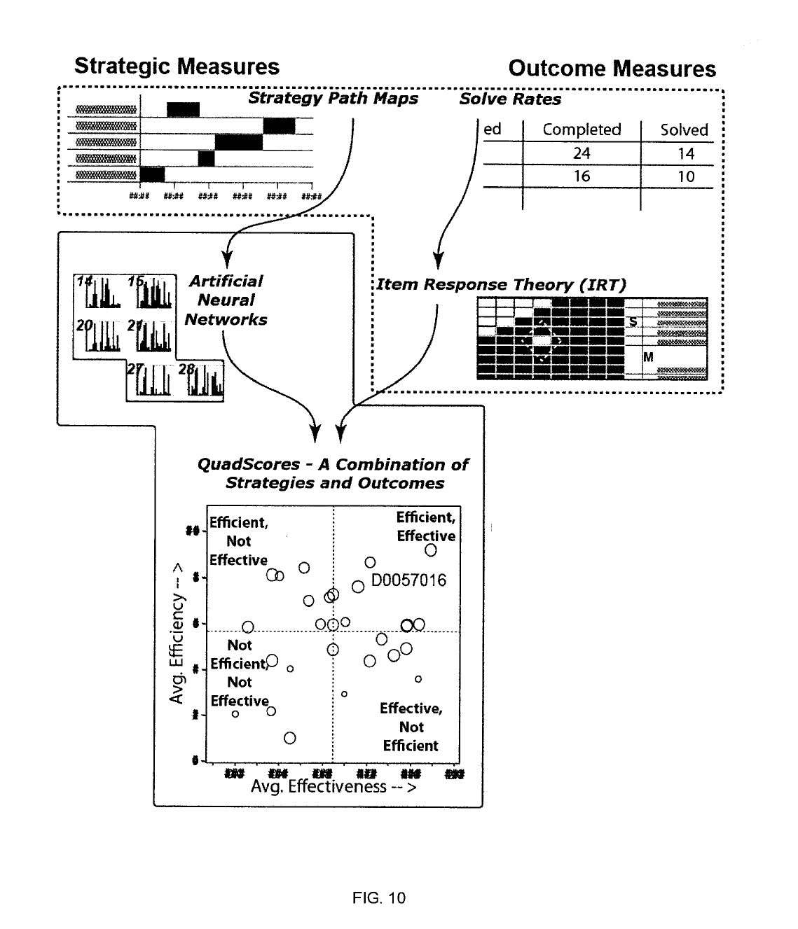

In one embodiment, the strategic efficiency values EI for a series of problem solving performances are plotted against the solve rate or outcome values, as generally illustrated on the left hand side of FIG. 9. The quadrants may be generated from the intersection of the average solve rate or outcome value and the average strategic efficiency value for thousands of students attempting the same problem set. The vertical and horizontal lines in FIG. 9 partition the strategy space into four quadrants used to divide the results into quantitative numeric values (QVs) representing the overall effectiveness and efficiency of student's problem solving strategies. Although the quadrants are of equal size in FIG. 9, in practice the lines may divide the plot into unequal size quadrants based on the data distribution, as illustrated in the examples of FIGS. 10 to 12.

In FIG. 9, the performances in quadrant 1 (upper left corner) mostly represent guessing and are assigned a quantitative value (QV) of ‘1’. Students in the lower left (or quadrant 2) order many tests, but fail to solve the problem and are assigned a QV of ‘2’. The lower right (quadrant 3) indicates performances where many tests are being ordered and the problem is being solved; these performances are assigned a QV of ‘3’. Finally, the most efficient performances where few resources are used and the problem is solved are located in Quadrant 4 and receive a QV of ‘4’. This method can be used to divide a large quantity of problem solving data into four groups to allow the effect of numerous different variables on the problem solving abilities of any desired sample of students to be determined quickly and easily, for example different teachers, differences between groups of students sorted based on criteria such as standardized test scores, sex, family income level, or the like, and improvement in abilities over time.

The right hand side of FIG. 9 shows how groups of students change their QVs as they gain problem solving experience. Any number of students may be used in this analysis. Initially most of the students are in Quadrants 2 and 3 indicating that they are extensively exploring the problem space; they may or may not be solving the problem. With experience, many students become more efficient problem solvers (Quadrant 4), while others may resort to guessing or continue to search extensively as they fail to identify/recognize the information that is essential for the answer (Quadrants 1 and 2). This method of generalizing student performance provides a single value for each student position on the efficiency plots. The vertical and horizontal lines in the plot intersect to divide it into four quadrants (not necessarily of equal size) defined for the average solve rate and EI of the problem sets, and such plots can be generated for any of the problem sets being used.

For an individual student, the QV metric therefore represents his or her proficiency in using resources to solve scientific problems effectively, abstracted across the specific problem sets administered to the student. As described shortly, this metric can be generated across problem sets over the course of the school year, and across different grades. By normalizing the vertex of the quadrant to the average EI and average solve rate for each problem set it also becomes possible to compare QVs across problem sets.

This method allows students' strategic proficiency to be tracked within a specific set of problem solving situations, and also allows monitoring of how well students' problem solving proficiency is improving as they encounter problems in different areas of science (for example, Grade 6: Earth Science; Grade 7: Life Science; Grade 8: Physical Science). It can document how collaborative learning and other forms of classroom intervention can improve learning and retention. Administratively, the metric can also be used to compare performance across classrooms, schools and districts.

FIG. 10 is a schematic flow diagram of the steps taken to produce a QV generating plot for a set of problems, as described above in connection with FIGS. 1 to 9. As illustrated in FIG. 10, data is collected on both student problem solving effectiveness or solve rate, and also on the techniques the student uses in order to solve the problem. This includes data on which menu items were selected, the sequence of selection, and the amount of time spent viewing each selection. The data map also indicates solve status, i.e. problem solved, problem completed without solving, or incomplete (abandoned without completing). On the upper right hand side, which includes the IRT analysis illustrated in FIG. 6 and described above, the data is analyzed to produce solve rates or effectiveness values (outcomes) which are used in generating the plot in the lower part of the drawing which is used to generate the QV scores for each student's input. The strategy input data in the upper left hand side of FIG. 10 is also used in the ANN analysis or modeling on the left hand side of FIG. 10 below the strategy path map in order to generate strategic efficiency or EI values which are plotted against the average solve rates or effectiveness values in the QV plot.

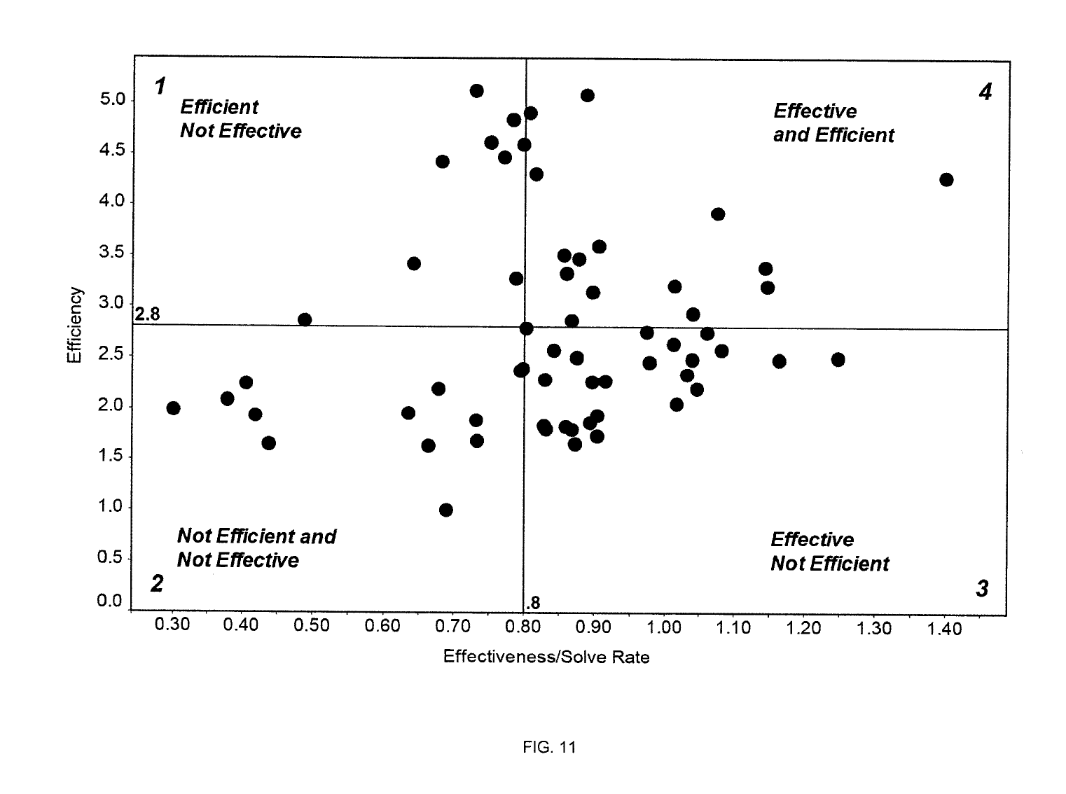

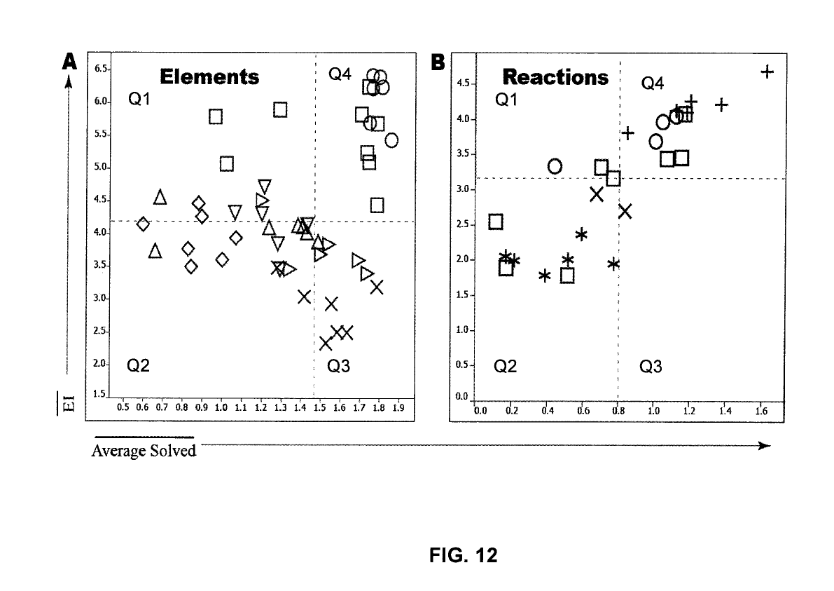

FIGS. 11 and 12 illustrate QV plots for some specific problem solving samples. FIG. 11 plots the average EI or strategic efficiency against the effectiveness or solve rate for a set of problem solving input data for 55 high school and university classes in USA and China. The class averages may be color-tagged by teacher. One notable feature is that different classes of the same teacher often cluster together. For instance, classes of teacher 7183 mainly occupy quadrant 2 while those of teacher 110 occupy quadrant 1. This is consistent with existing research showing that there is a significant teacher contribution to the student's technique for solving problems. When students perform multiple cases in a problem set, an average placement on a map plotting EI against solve rate can be generated by determining the ANN node represented by each strategy, and averaging the associated EI values, and then plotting this value vs. the average solve rate.

In FIG. 11, the vertical line is at an average solve rate of 0.8 while the horizontal line is placed at an average EI of 2.8. The positions of the vertical and horizontal lines vary dependent on the input data used to generate the plot, as discussed above. The vertical line is placed at the solve rate average for the data points, while the horizontal line is placed at the overall EI average for the data points, as described above in connection with FIG. 9.

FIGS. 12A and 12B illustrate other examples of plots similar to FIG. 11 used to analyze different problems approached by different students and determine QV scores for each student. FIGS. 12A and 12B are examples of middle school classroom distributions of EI and Solve Rate for two different problem sets. In this example, the student EI and Solved values on the middle school chemistry problem sets (Elements and Reactions) were aggregated for 52 classes of seven teachers. The symbol types denote the classrooms of each teacher. The horizontal and vertical dotted lines indicate the overall EI and Solve Rate averages, respectively, and partition the strategy space into four quadrants.

In FIGS. 12A and 12B, each symbol represents the classrooms of one teacher. As shown by the similar shapes in the figures, different classrooms of the same teacher are often clustered together on the quadrant maps, indicating that teaching styles have an impact on problem solving strategies and effectiveness.

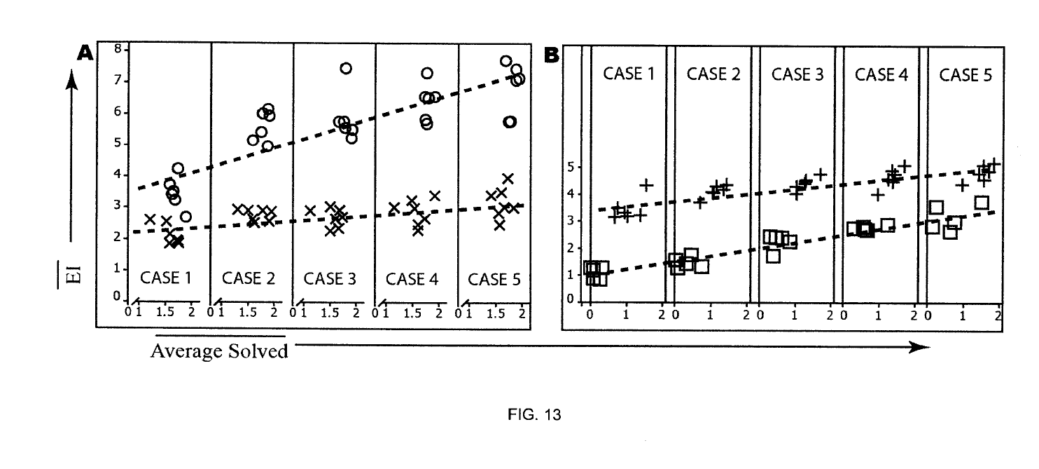

Given the across-classroom performance differences, a teacher-by-class comparison of student progression may be performed. The results of such a comparison are illustrated in FIGS. 13A and 13B. The example of FIG. 12 uses four teachers. FIG. 13 illustrates student improvements in EI and solve rate with practice for two of the teachers, divided on a classroom by classroom basis. The EI and solved rates of the classes of two teachers for Elements (X, O) and for Reactions (+, ▪) are plotted for the first 5 case performances for each problem set in FIGS. 12A and 12B. The dotted lines plot the class means for the different teachers.

On the problem set Elements (FIG. 12A, 13A), all classes of both teachers improved their average solve rates with practice, but the classes of one teacher (O) showed greater strategic improvement that did the classes of the other (X). A different progress pattern is shown in FIG. 13B for the Reactions problem set where the classes of the two teachers being analyzed differed in both the starting EI and solved rates, but improved across both dimensions at similar rates on subsequent cases. These results suggest a consistent teacher component to student's strategic development.

Through a normalization (or norming) process, QV scores generated in the method described above can provide:

A measure of strategic competency based on the performance of any person relative to all of the members that are being compared,

Performance standards for the various groups (i.e., grade levels, classes, schools, nations),

A determination of which students have exceptional ability in any group,

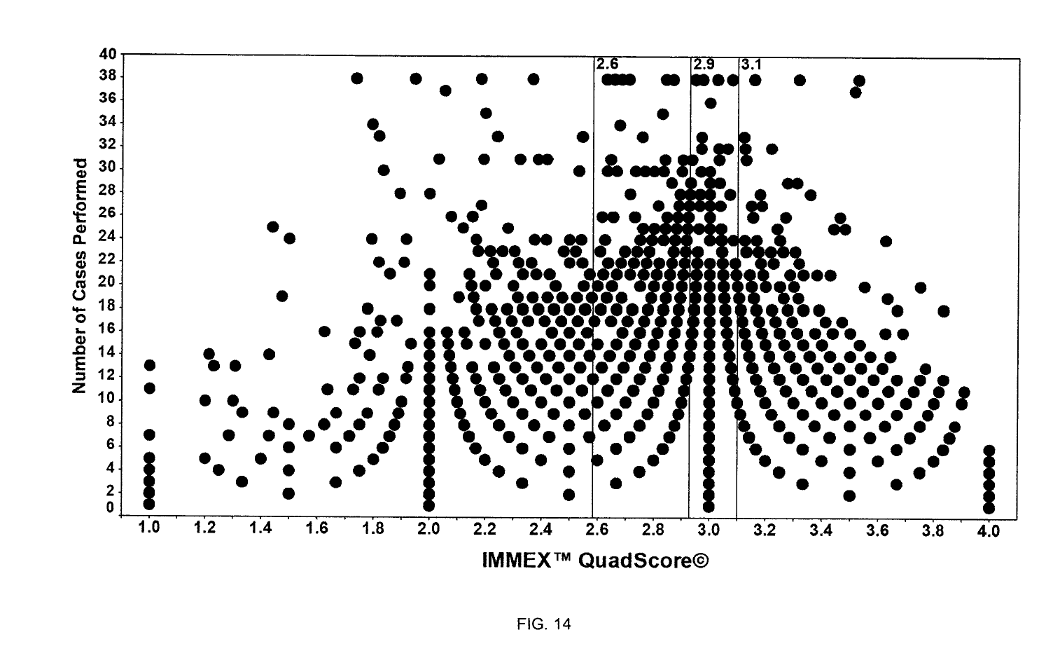

A determination of the efficacy of programs that are designed to improve performance, as well as other types of performance comparisons. An example of a normalized QV score distribution for one problem set is shown in FIG. 14, where the different shades representing average number of problems solved.

The system and method described above is also used to generate online performance reporting tools for teachers and/or administrators. One significant challenge that science teachers face when they work with on-line instructional resources is that it can be difficult to monitor the quality of students' work and progress when students are working at the computer. The QV scores described above can be used to provide various reports to allow practitioners (teachers, administrators, or others) to monitor students' activities and progress in developing scientific problem solving skills, both within the problem set currently being used, and across problem sets (i.e., domain-independent problem). FIG. 15 illustrates one example of an online interface which may be used by practitioners to obtain various levels of reports based on QV scores generated by the system and method described above. Although the various levels of reports illustrated in FIG. 15 are displayed as pie-charts in a dashboard like format, other types of reports may also be generated in the report generating module 14 of FIGS. 1 and 3, such as tables of QV scores, bar charts, graphs, and the like.

FIG. 15 illustrates several levels of reports 70, 75, 80, and 85 which can be obtained online by a user who may be a teacher, administrator, or other individual involved in a teaching environment by clicking on the display to drill down from one level to the next. In the report 70 at the top of FIG. 15, QV scores for all students being monitored in a set of classes of one teacher are displayed, for a set of problems. If a teacher or other individual wishes to retrieve data for a specific problem, they can select a problem by clicking on a selected location on the report screen 70, and are then directed to a problem-specific report screen as illustrated at the left hand side of levels 75, 80, and 85 for all performances on a specific problem. In the illustrated example, the teacher has retrieved performance results for all classes for a problem identified as “Paul's Pepperoni Pizza”.

The user can drilldown from this screen to obtain a comparison of QV scores for all students attempting that problem (right hand side of 75), or for one specific class (right hand side of 80), or individual student performances (right hand side of 85). At level 80, a teacher has retrieved the performance results for her seven classes (indicated by the petals of the rose diagram on the left hand side of level 80). She can see that the classroom implementation differs for the classes with some performing many cases of the problem Paul's Pepperoni Pizza (at 7 o'clock for instance) and others performing few (at 2 and 3 o'clock). Drilling down on one class to the screen on the right hand side of level 80, the teacher can see that the strategies of this class are quite diverse, with over a third with QV=4 (efficient and effective) and a similar number with QV=2 (not efficient, not effective), suggesting that multiple interventions may be needed to reach all learners. The teacher can also drill down from this screen to receive a report of individual student performances, as seen on the right hand side of level 85, allowing possible intervention with students identified as needing help with the type of problem involved.

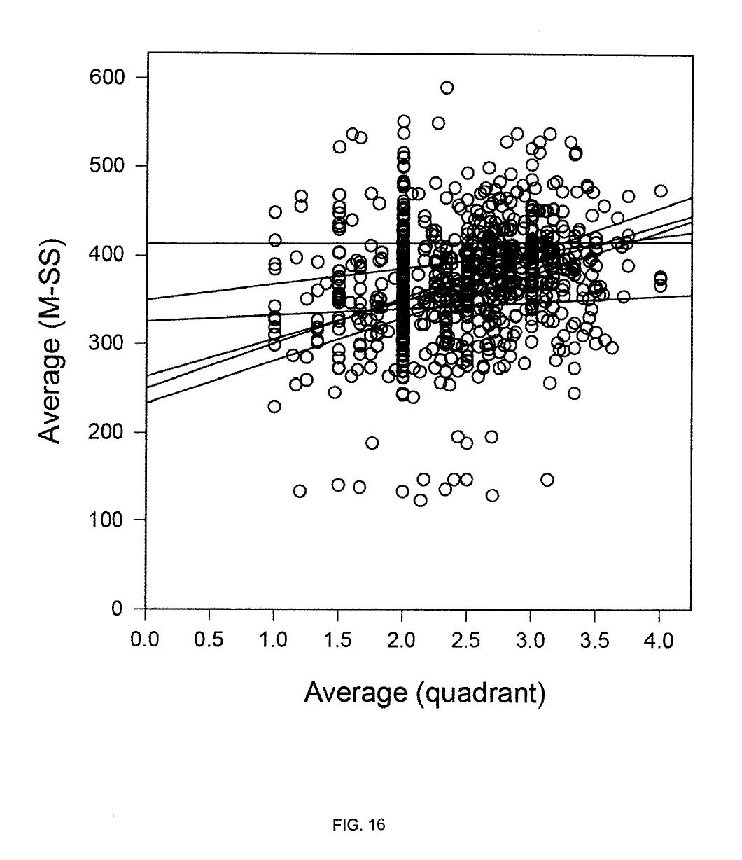

FIG. 16 illustrates another report which may be generated using QV scores. This reports compares QV scores of students of different teachers to the students' standardized test score, such as the California Achievement Test (CAT) score. This report can determine whether teachers are preparing their students well for problem solving. If students are being well prepared, a moderate positive correlation should exist between problem solving metrics and test scores. Although this report is shown in the form of a plot of data for different teachers, it may alternatively be generated as a pie chart, bar chart, or the like. In the illustrated example, the student population consisted of middle school students (N=775) from multiple classes of six teachers where the CAT mathematics scores (M-SS) were also available. The students attempted to solve 4-6 different problem sets (between 25-60 different cases total) over a year's time. The QV measure was regressed for all performances against the M-SS test scores. A correlation between QV and the M-SS scores was seen for some teachers, but not for the others. This was not due to differences in the overall achievement levels of the students in the different classes; in fact, the two highest achieving classes (by the M-SS scores) were the most poorly correlated. In the lower M-SS performing classes, most students are at QV=2. These are students who appear to be looking extensively at the data but repeatedly failing to solve the problems during the school year, suggesting that their teachers are not preparing them to carefully select and synthesize data.

In another example, a sample of students (N=137 representing ˜3500 problem solving performances) performed cases from five problem sets spanning the domains of chemistry, math, and biology, allowing correlations to be made for IRT, EI and QV. For 119 of these students, the California Achievement Test scores in Reading, Language and Math were also available. Using these aggregated values, a multiple regression analysis was conducted to evaluate how well the IRT, EI and QV predicted CAT Math scores. The linear combination of the three measures was significantly related to the standardized scores (F(3,118)=24.5, p<0.001). The sample multiple correlation was 0.57 indicating that approximately 32% of the variance in the CAT scores could be accounted for by these measures. The QV (r=0.17) and IRT (r=0.32) scores both contributed significantly (p<0.001) to the prediction of CAT Math scores while EI was not correlated.

Reports comparing QV score results for different teachers as described above allow administrators or others to determine which teachers have the best teaching strategy for a particular type of problem, and to identify teachers for which professional development or mentoring by teachers identified as having better teaching strategies may be helpful. As discussed above, other reports generated by the above embodiments may compare student results on similar problems over time or based on other factors.

The method described above can be used to quantify diverse problem solving results in terms of outcomes that are comparable across learning events and different problem solving tasks. This approach combines the efficiency of the problem solving solution as well as its correctness. These are components of most problem solving situations and may applied across diverse problem solving domains and disciplines which may extend from classroom or online education to business, healthcare, or other fields where training is an important factor. In essence, the problem solving analysis system and method described above seeks to improve outcomes with the minimal consumption of time and resources.

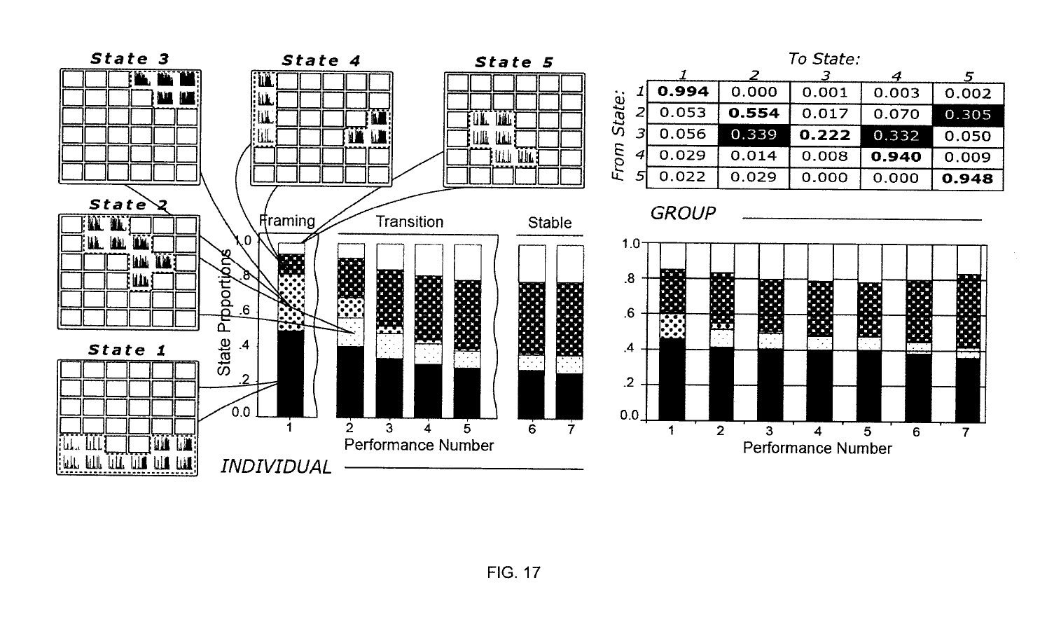

FIGS. 17 to 19 illustrate an alternative method of modeling to generate a bar chart modeling individual and group learning trajectories using ANN and HMM neural network analysis, using different criteria from the four QV scores described in the first embodiment to represent problem solving strategies. The method of this embodiment quantifies a number of unknown states in a dataset representing strategic transitions that students may pass through as they perform a series of problems. These states might represent learning strategies that task analyses suggest students may pass through while developing competence. Then, similar to the previously described ANN analysis, exemplars of sequences of strategies (ANN node classifications) are repeatedly presented to the HMM modeling software to develop temporal progress models. The resulting models are defined by a transition matrix that shows the probability of transiting from one state to another, and an emission matrix that relates each state back to the ANN nodes that best represent student performances in that state.

In one example, when students' performance was mapped to their strategy usage as mapped by the HMM states, these states revealed the following quantitative and qualitative characteristics:

State 1—55% solution frequency showing variable, but limited numbers of test items and little use of Background Information;

State 2—60% solution frequency showing equal usage of Background Information as well as action items; little use of precipitation reactions.

State 3—45% solution frequency with nearly all items being selected.

State 4—58% solution frequency with many test items and limited use of Background Information.

State 5—66% solution frequency with few items selected Litmus test and Flame tests uniformly present.

The critical components of one example of such an analysis are shown in FIG. 17 where students solved seven problems (in this case HAZMAT problems as discussed above in connection with the first embodiment) and then their ANN strategies and HMM states were modeled. The resulting five different HMM states reflect different strategic approaches with different solution frequencies. In this figure, one level of analysis (stacked bar charts) shows the distribution of the 5 HMM states across the 7 performances. On the first case, when students are framing the problem space, the two most frequent states are States 1 and 3. Moving up an analytical layer from HMM states to ANN nodal strategies (the 6×6 histogram matrices) shows that State 3 represents strategies where students ordered all tests, and State 1 where there was limited test selection. Consistent with the state transitions in the upper right of FIG. 17, students transited from State 3 (and to some extent State 1), through State 2 and into States 4 and 5 with experience, i.e. moving towards the more effective states. By the fifth performance, the State distributions stabilized after which time students without intervention tended not to switch their strategies, even when they were ineffective. Stabilization with ineffective strategies is of concern as described below, as students tend to retain their adopted strategies over at least a 3-months period.

From the associated transition matrix, State 1 is an absorbing state meaning that once students adopt this approach they are likely to continue using it on subsequent problems. In contrast, States 2 and 3 are more transitional and students are likely to move to other approaches as they are learning. State 5 has the highest solution frequency, which makes sense because its ANN histogram profile suggests that students in this state pick and choose certain tests, focusing their selections on those tests that help them obtain the solution most efficiently.

The solution frequencies at each state provide an interesting view of student progress. For instance, if we compare the earlier differences in solution frequencies with the most likely state transitions from the matrix shown in FIG. 17, we see that most of the students who enter State 3, having the lowest problem solving rate (27%), transit either to State 2 or 4, and increase their solution frequency by 13% on average. Students performing in State 2 are more likely than those in State 4 to transit to State 5 (with a 14% increase in solution frequency). From an instructional point of view, these results suggest that students who are performing in State 3 might be guided toward State 2 rather than State 4 strategies.

In one embodiment, the modeling system may optionally be expanded to include the effects of a common intervention, collaborative learning, and by testing the effects of gender on the persistence of strategic approaches. These options are illustrated in FIGS. 17 to 19, and involve collection of problem solving inputs from groups of students 18 via collaboration server 55 of FIG. 4. The groups of students or learners may be at the same physical location (e.g. in a classroom using one or more computers), or may be at remote locations and linked together via collaboration server 55 so that they can chat with one another, as generally illustrated in FIG. 4.

There are many theories to support the advantages of collaborative learning in the classroom, which has the potential to increase task efficiency and accuracy while giving each team member a valued role grounded in his or her unique skills. Although it is not always the case, groups sometimes even outperform the best individual in the group. Here, working in pairs encouraged the students to generate new ideas that they probably would not have come up with alone. These studies suggest that the ability of a group may somehow transcend the abilities of its individual collaborators. Learning and working with peers may benefit not only the overall team performance by increasing the quality of the team product; it may also enhance individual performance. Increasingly, intelligent analysis and facilitation capabilities are being incorporated into collaborative distance learning environments to help bring the benefits of a supportive classroom closer to the distant learners.

FIG. 17 illustrates a learning trajectory for 5452 Hazmat performances from students working collaboratively in groups of 2 or 3. Consistent with the literature, students working collaboratively significantly increased their solution frequency (from 51% to 63%). As importantly, ANN and HMM performance models showed that the collaborative learners stabilized their strategies more rapidly than individuals, used fewer of the transitional States 2 and 3 and more State 1 strategies (limited and/or guessing approaches). This suggests that group interaction helped students see multiple perspectives and reconcile different viewpoints, events that seem associated with the transitional states. Collaboration may, therefore, have replaced the explicit need for actions that are required to overcome impasses, naturally resulting in more efficient problem solving.

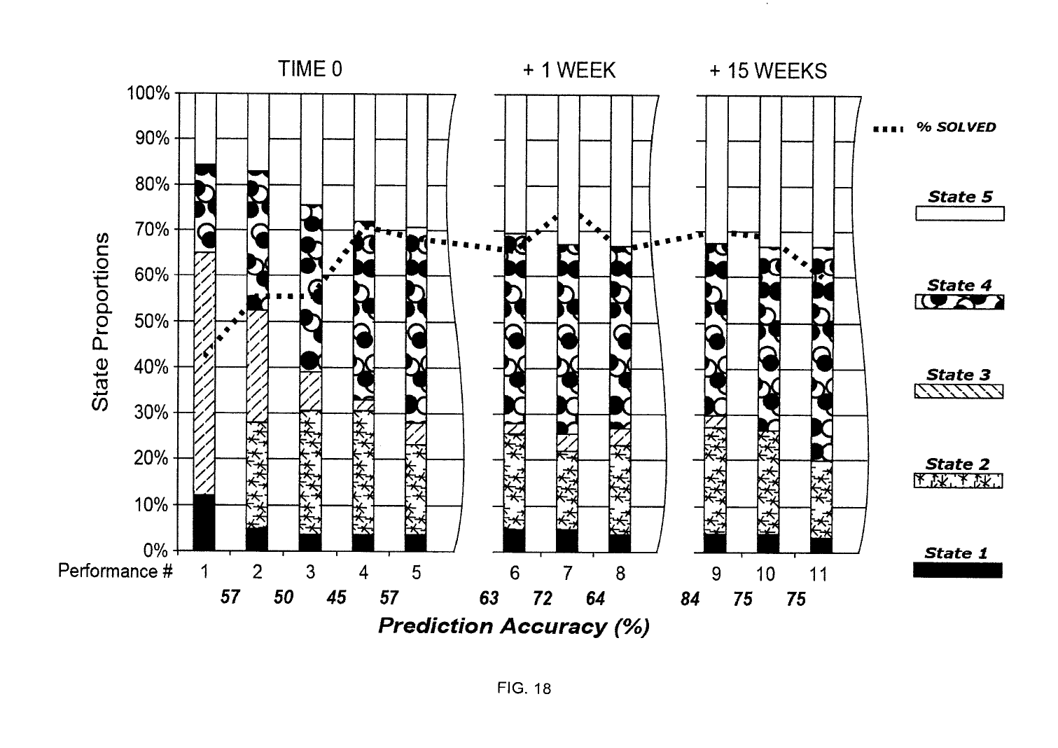

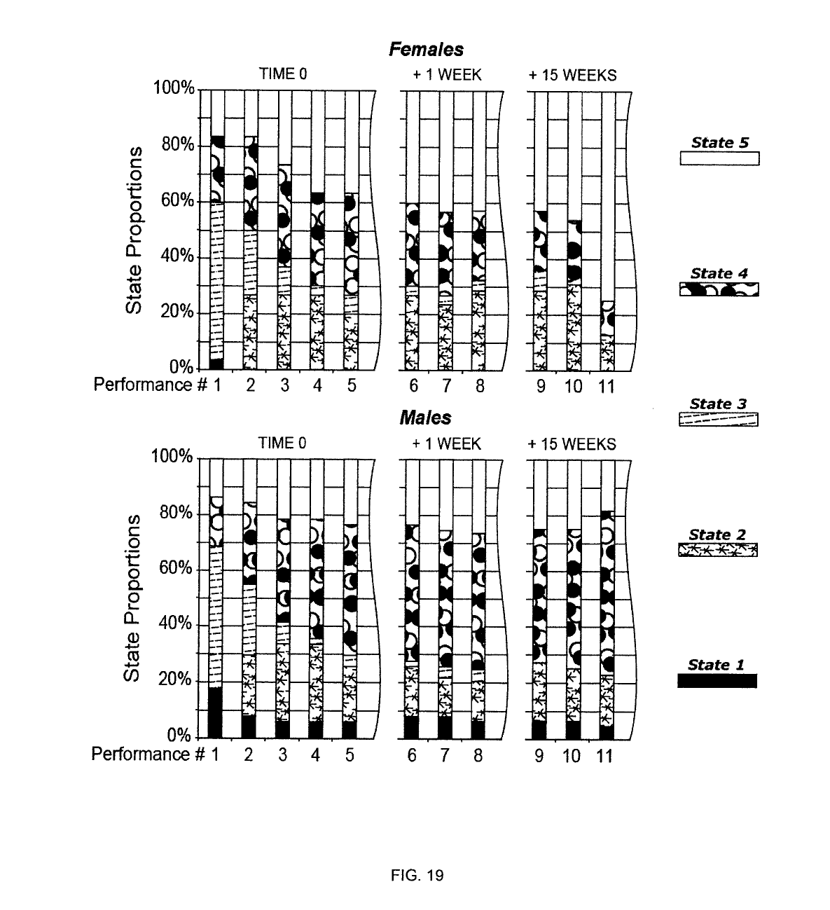

One important consideration would be the dynamics of the state transitions as reflected in the transition matrix derived from the modeling process. Here theories of practice and cognition predict that students change strategies with practice and eventually stabilize with preferred approaches, as is indicated in FIGS. 18 and 19. Similarly, the general overall shift in states from those representing extensive exploration to more refined test selection mirrors the data reduction effects observed previously with practice. For instance, most students in the example of FIG. 18 approached the first Hazmat case by selecting either an extensive (State 3), or limited/guessing (State 1) amount of information. The State 3 approaches would be appropriate for novices on the first case as they strive to define the boundaries of the problem space. Persisting with these strategies, however, would indicate a lack of understanding and progress.

The states that students stabilize with presumably reflect the level of competence as well as the approach they feel comfortable with. These approaches are the ones that would most often be recognized by teachers and for Hazmat were represented by States 1, 4 and 5. State 4 is interesting in several regards. First, it differs from the other states in that the strategies it represents are located at distant points on the ANN topology map, whereas the nodes comprising the other states are contiguous. The State 4 strategies represented by the left hand of the topology map are very appropriate for the set of cases in Hazmat that involve flame test positive compounds, whereas those strategies on the right are more appropriate for flame test negative compounds (where more extensive testing for both the anion and cation are required). This suggests that students using State 4 strategic approaches may have mentally partitioned the Hazmat problem space into two groups of strategies, depending on whether the initial flame test is positive.

State 5 also contains complex strategies which from the transition matrix emerge from State 2 strategies by a further reduction in the use of background resources. State 5 approaches appear later in problem solving sequences, have the highest solution frequencies and are approaches that work well with both flame test positive and negative compounds. In this regard they may represent the outcome of a pattern consolidation process.

With a smaller set of advanced placement chemistry students (3 classrooms from the same teacher, 79 students) the short and long-term stability of student's strategies and the influences that gender plays in strategy persistence may be explored. In a standard classroom environment, students first performed 5 Hazmat problems to refine and stabilize their strategies. Then, one week (short-term) and 15 weeks later (long-term) students were asked to solve additional Hazmat cases. The data produced in these tests was modeled using the modeling techniques described above to produce the bar chart of FIG. 19.

At the end of the required first-set of performances (# 1-5), the proportions of the five strategy states and the solution frequencies had stabilized. As expected, State 3 approaches were preferred on the early problem solving performances, and these decreased over time with the emergence of States 2, 4, and 5. The proportion of State 1 strategies in this subset of students was lower than the overall population, and this was most likely due to the more controlled classroom nature of this assignment that reduced guessing.

One week, and fifteen weeks later the students were asked to perform an additional 3 Hazmat cases in class. The state distributions of the performances at both time intervals were not significantly different from those established after the initial training. It is also interesting that the solution frequency also did not change. Combined, these data indicate that students adopt a preferential approach to solving Hazmat after relatively few cases (4-5) and, as a group, they continue to use these strategies when presented with repeat cases, even after prolonged periods of time.

The performances were then separated by gender and the state distributions were re-plotted. As shown in FIG. 19, both male and female students appeared to have stabilized their strategic approaches by the fifth performance, but the state distributions were significantly different, with females preferring the approaches represented by State 5 whereas the males preferred State 4 approaches.

The methods and systems of the embodiments described above can help educators in understanding students' shifting dynamics in strategic reasoning as they gain problem solving experience. The above embodiments develop targeted feedback reports which can be used by teachers and students to improve learning. The analytic approach in the above methods is multilayered to address the complexities of problem solving. This analytic model combines three algorithms (IRT, ANN and HMM), which, along with problem set design and classroom implementation decisions, provide an extensible system for modeling strategies and formulating interventions. When combined, these algorithms provide a considerable amount of real-time strategic performance data about the student's understanding, including the IRT person ability estimate, the current and prior strategies used by the student in solving the problem developed using IRT and HMM analysis as described above, and the strategy the student is most likely use next, all of which provide information important to constructing detailed models of the development of scientific understanding. These findings are contingent on the validity of the tasks as well as the performance and strategic models developed from the student data.

In the above description, examples are given on validating one representative problem set, Hazmat, where to date; over 81,000 performances have been recorded by high school and university students. This problem set covers much of the spectrum of qualitative analysis with 38 parallel cases that include acids, bases, and flame test positive and negative compounds. The tasks also have construct validity in that cases are of different difficulties by Item Response Theory analysis, and these differences correlate with the nature of the compounds (e.g. flame test positive compounds are easier than flame test negative compounds). In the first modeling step the most common strategies used by students are grouped by unsupervised ANN analysis and the resulting classifications show a topology ranging from those where very few tests were ordered, to those where every test was selected, which makes sense given the nature of the input data (i.e. deliberate student actions). The HMM progress models are somewhat more difficult to validate given the hidden nature of the model.

An advantage of HMM is that it supports predictions regarding future student performances. By using the current state of the student and the transition matrix derived from training, a comparison of the ‘true’ value of a students' next state, with the predicted values resulted in model accuracy at 70-90%. The ability to model and report these predictive measures in real time provides a structure around which to begin developing dynamic interventions that are responsive to students' existing approaches and that aim to modify future learning trajectories in ways that enhance learning.

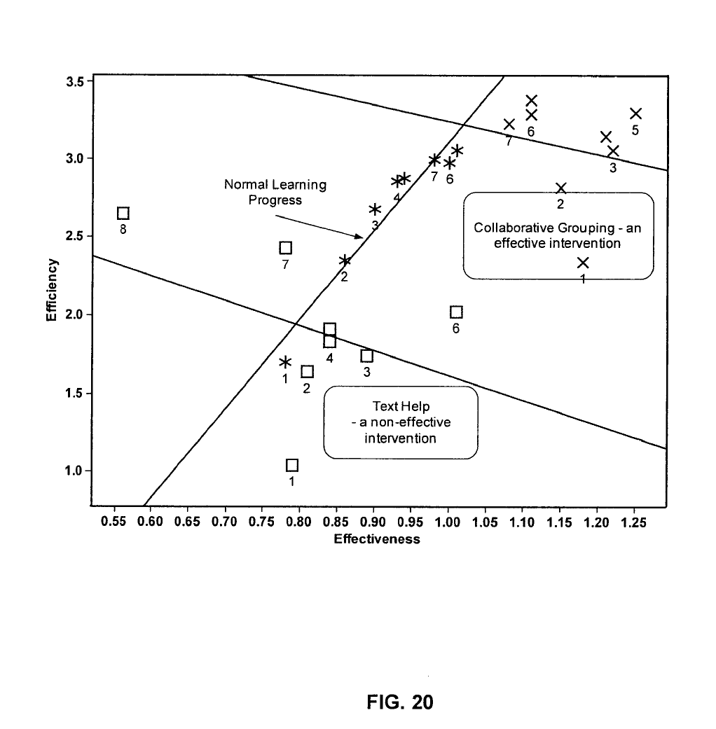

Reports generated as described above can be readily linked to interventions that teachers might use with individual students or the class as whole. Reports may be generated which compare QV scores across learning events so that students and teachers can track growth (or lack of growth) in learning. The system and method described above provides rigorous and reliable measures of student progress, and can be progressively scaled and refined in response to evolving student models and new interventional approaches. For instance, FIG. 20 shows normal learning progress as increases in both efficiency and effectiveness as students performed eight problems. One intervention, collaborative grouping, has a positive effect by accelerating the effectiveness of the outcomes. Conversely, non-specific text help messages retarded the progress of both the problem solving efficiency and effectiveness.

Those of skill will appreciate that the various illustrative logical blocks, units, modules, circuits, and algorithm steps described in connection with the embodiments disclosed herein can often be implemented as electronic hardware, computer software, or combinations of both. To clearly illustrate this interchangeability of hardware and software, various illustrative components, units, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks, components, units, and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A computer implemented method of evaluating problem solving skills, comprising:
receiving and storing problem solving input data from a group of students for a series of problems attempted by the students, the data including problem solving status and use of online resource items by each student attempting the problems;
analyzing the collected problem solving status data to determine problem solving effectiveness for each problem attempted by each student;
analyzing the collected data on use of online resources for each problem attempted using a trained artificial neural network (ANN), the ANN analysis generating a problem solving efficiency value based on the selection frequency of each online resource item for each problem attempted by each student;
comparing the problem solving effectiveness values to the problem solving efficiency values;
using the comparison to generate a quantitative numeric value (QV) for each student's problem solving proficiency for each problem in the series, the QV comprising a combination of problem solving efficiency and problem solving effectiveness;
storing the QV data;
using the stored QV data to generate problem solving reports including a report comparing QV values for all students and all problems, reports comparing QVs on a problem by problem basis, and reports comparing individual student QVs; and
providing the reports online as feedback to supervisors, whereby teaching strategies can be modified for students identified as having low QV scores.

2. The method of claim 1, further comprising receiving problem solving data for successive sets of similar problems from the group of students at predetermined time intervals and comparing QVs over time to generate reports on students' problem solving progress.

3. The method of claim 1, wherein problem solving effectiveness data is generated using item response theory (IRT) modeling.

4. The method of claim 1, wherein problem solving effectiveness data is generated using problem solution frequency.

5. The method of claim 1, further comprising receiving input data identifying the teacher of each student in the group and associating each stored student QV with the identity of the student's teacher, the reports including reports comparing results of each teacher for each problem taught, whereby effective teaching strategies can be identified for teachers having students with high QVs.

6. The method of claim 1, wherein the QVs comprise at least a QV of 1 corresponding to students using few resources and having a low problem solving outcome, a QV of 2 corresponding to students using many resources and having a low problem solving outcome, a QV of 3 corresponding to students using many resources and having a high problem solving outcome, and a QV of 4 corresponding to students using few resources and having a high problem solving outcome.

7. The method of claim 6, wherein the comparison of problem solving effectiveness to problem solving efficiency comprises producing a plot of problem solving efficiency against problem solving rate, and the QVs are generated by dividing the plot into four quadrants separated by two intersecting lines corresponding to the average effectiveness value and average problem solving efficiency for the set of data analyzed, all points in the upper left hand quadrant being assigned a QV of 1, all points in the lower left hand quadrant being assigned a QV of 2, all points in the lower right hand quadrant being assigned a QV of 3, and all points in the upper right hand quadrant being assigned a QV of 4.

8. The method of claim 7, further comprising associating student identifiers with each point in the plot, and providing an output report for students or supervisors based on the plot.

9. The method of claim 7, further comprising associating teacher identifiers with each point in the plot, and providing an output report to students or supervisors based on the plot.

10. The method of claim 1, further comprising comparing student QVs with standardized test scores on a student by student basis, and providing an output report to supervisors, whereby students having high test scores but low problem solving outcomes, or low test scores with high problem solving outcomes can be identified for intervention.

11. The method of claim 1, further comprising collecting sets of student problem solving input data for the same students at predetermined time intervals, each set being associated with a group of problems related the problems in the other sets, generating QVs for each set of data in the series, and using Hidden Markov Modeling (HMM) to generate learning trajectories across the series of student problem solving performances, developing stochastic models of problem solving progress from the learning trajectories across sequential strategic stages in the learning process, and providing student progress reports based on the generated models.

12. A method of analyzing students problem solving ability, comprising
collecting problem solving input data from users for a series of different problems attempted by the students at different time intervals, the data including problem solving outcomes and problem solving resources used by the users in attempting each problem;
processing the collected problem solving outcome data to generate outcome values which indicate problem solving effectiveness;
processing the collected data on use of resources by each user in attempting each problem to generate strategic efficiency values for each user and problem, the strategic efficiency value being based on the resources used by the users in attempting each problem;
comparing the outcome values with the strategic efficiency values;
using the comparison to generate a set of at least four quantitative numeric values (QV scores) representing each student's problem solving ability, the lowest QV score comprising user problem solving attempts with a low outcome combined with low use of resources and the highest QV score comprising user problem solving attempts with high outcome combined with low use of resources; and
generating reports which indicate the number of users in each QV score category for each problem attempted, whereby the reports are a measure of user problem solving proficiency and can be used by supervisors to determine effectiveness of teaching strategies and to modify identified teaching strategies associated with low QV scores.

13. The method of claim 12, wherein the outcome values representing problem solving effectiveness are generated using item response theory (IRT) modeling.

14. The method of claim 12, wherein the strategic efficiency values are generated using a trained artificial neural network (ANN).

15. The method of claim 14, further comprising using Hidden Markov Modeling (HMM) to generate learning trajectories from the problem solving effectiveness values and strategic efficiency values.

16. The method of claim 12, wherein the reports comprise pie charts.

17. The method of claim 12, further comprising displaying the reports on a video display output screen.

18. The method of claim 17, wherein the reports are displayed in the form of a dashboard-like image on a computer display screen.

19. The method of claim 17, wherein the reports comprise at least a first report displaying a comparison of QV scores for all users and all problems and a series of second, problem based reports, each second report comprising a comparison of QV scores for all users for a respective problem.

20. The method of claim 19, wherein the reports further comprise a series of individual user performance reports.

21. The method of claim 19, wherein the reports further comprise a series of teacher based reports each displaying QV scores for all users taught by a respective teacher.

22. The method of claim 19, wherein the reports further comprise progress reports which compare QV scores generated for each user for a series of similar problem sets attempted after a series of successive time periods.

23. The method of claim 19, wherein the input data further comprises problem solving input data from groups of users collaborating together to solve problems, and the reports further comprise third reports which compare QV scores for individual users attempting problems with QV scores for collaborative groups attempting problems together.

24. The method of claim 12, wherein the step of comparing the outcome values with the strategic efficiency values comprises plotting the outcome values against the strategic efficiency values, and the step of generating QV scores for each point in the plot comprises dividing the plot into four quadrants separated by the average outcome value and the average strategic efficiency value for the set of data, and assigning each point in an upper left hand quadrant a QV score of one, assigning each point in the lower left hand quadrant a QV score of two, assigning each point in the lower right hand quadrant a QV score of three, and assigning each point in the upper right hand quadrant a QV score of four.

25. A computer implemented problem solving analysis system, comprising:
an input module which receives problem solving input data from students for a series of different problems attempted by the students, the data comprising problem solving outcome data and data on resources used by students in attempting to solve problems;
a data storage module which stores problem solving input data for the students and associated student identifying data;
a central processor which analyzes the stored data, the processor comprising a problem solving effectiveness module which processes the collected problem solving outcome data to generate outcome values representing problem solving effectiveness for each problem and student attempting the problem, a strategic efficiency module which processes the collected data on resources used by students for each problem to produce strategic efficiency values based on problem solving strategies, a comparison module which compares the outcome values with the strategic efficiency values, a quantitative value (QV) generating module which assigns a quantitative numeric value to each problem solving attempt on a student-by-student basis, and a report output module which generates reports comparing QVs for all problems attempted; and
a display module which displays selected QV reports to users of the system on request.
